(19) United States
(12) Patent Application Publication
(10) Pub. No.: US 2004/0128970 A1
(43) Pub. Date: Jul. 8, 2004

(54) Direction changing feature for lawnmower discharge

(76) Inventor: Richard E. Gazlay, Tampa, FL (US)

Correspondence Address: Richard C. Litman, LITMAN LAW OFFICES, LTD., P.O. Box 15035, Arlington, VA, 22215, US

(21) Appl. No.: 10/732,479

(22) Filed: Dec. 11, 2003

Related U.S. Application Data
(60) Provisional application No. 60/437,750, filed on Jan. 3, 2003.

(51) Int. Cl. A01D 67/00

(52) U.S. Cl. 56/320.2

(57) ABSTRACT

A direction changing feature for lawnmower discharge that allows the operator of a lawnmower to spontaneously select which side of a lawnmower the discharge of grass clippings exits. The device is made up of two hinged flaps that are each connected by linking rods to a shift rod. Each flap is shaped and dimensioned to cover one of two openings on opposite sides of a lawnmower housing. When the shift rod is at rest in one of its two positions, one of the flaps covers an opening while the other flap is positioned such that the second opening is unobstructed. When the shift rod is shifted into its second position, the flap covering an opening is lifted thereby exposing that opening while the other flap closes over the second opening. A new lawnmower can be manufactured with the device incorporated into its housing, or an existing lawnmower can be retrofitted with the device.

### CROSS-REFERENCE TO RELATED APPLICATION

This application claims the benefit of U.S. Provisional Patent Application Serial No. 60/437,750, filed Jan. 3, 2003.

### BACKGROUND OF THE INVENTION

1. Field of the Invention

The present invention relates to lawnmowers and, more specifically, to a device for selectively directing the discharge from a lawnmower.

2. Description of Related Art

Conventional lawnmowers are well known in the art. Such devices typically consist of a wheel-mounted lawnmower housing containing a rotating blade, with the blade driven by a motor mounted on top of the housing. A discharge opening or chute is typically located on one side of the housing to allow grass clippings to exit the housing via a stream of exhaust air. The discharge opening or chute is typically formed by the shape of the housing and therefore is permanently located on one of the two sides of the housing.

Because the side from which grass clippings exit a lawnmower is fixed, grass clippings are often blown into areas where such clippings are not desired such as pools, screened patios and walkways. This typically occurs in situations where the lawnmower cannot be easily oriented such that the discharge chute is pointing in a desired direction. Given this problem, there is a need for a device that allows the operator of a lawnmower to select which side of the lawnmower grass clippings will be blown from, particularly for use by commercial operators, landscapers, farmers, highway workers, etc.

Devices are known in the art that enable discharge from certain lawnmowers to be directed in different directions. Each of U.S. Pat. No. 5,033,260 issued Jun. 23, 1991 to F. L. Jerry and U.S. Pat. No. 5,107,566 issued Apr. 28, 1992 to R. J. Schmid disclose a discharge direction changing device that attaches to the rear of a lawnmower housing. Structurally, however, these devices differ from the present invention in that they both include enclosed chutes that are shaped and dimensioned to attach to an opening located in the rear of a lawnmower housing. Therefore, neither can be attached to a traditional lawnmower, which has an exhaust chute on one side, without significant retrofitting of the lawnmower housing. Additionally, if attached to a traditional walk-behind lawnmower, each would obstruct the area in which the operator of the lawnmower walks. Furthermore, the enclosed chute of each would be subject to clogging by accumulation of grass clippings within the chute.

U.S. Pat. No. 5,826,416 issued Oct. 27, 1998 to D. J. Sugden et al. discloses a dual discharge system for a lawnmower that either discharges grass clippings on one side of the lawnmower or into a collection bin. U.S. Pat. No. 6,105,350 issued Aug. 22, 2000 to B. Vachon et al. discloses a multiport hopper exhaust device that allows exhaust from a grass collection hopper, without grass clippings, to exit on either side of the hopper. Structurally, these devices differ from the present invention in that they include enclosed chutes. Furthermore, neither is structurally compatible with a walk-behind type of lawnmower.

Consequently, none of the above inventions and patents, taken either singly or in combination, is seen to describe the instant invention as claimed.

### SUMMARY OF THE INVENTION

The present invention is a device that allows the operator of a lawnmower to spontaneously select which side of a lawnmower the discharge of grass clippings exits. The device is comprised of two hinged flaps that are each connected by linking rods to a shift rod. Each flap is shaped and dimensioned to cover one of two openings on opposite sides of a lawnmower housing. When the shift rod is at rest in one of its two positions, one of the flaps covers an opening while the other flap is positioned such that the second opening is unobstructed. When the shift rod is shifted into its second position, the flap covering an opening is lifted, thereby exposing that opening while the other flap closes over the second opening. A new lawnmower can be manufactured with the device incorporated into its housing, or an existing lawnmower can be retrofitted with the device.

Accordingly, it is a principal object of the invention to provide a lawnmower side discharge device that allows the operator of a lawnmower to select from which side of the lawnmower grass clippings will be discharged and thereby reduce the time required for cleaning grass clippings discharged into an area where such clippings are not desired.

It is another object of the invention to provide a device that is simple and easy to use and that allows the direction of lawnmower discharge to be changed quickly and with minimal effort.

It is a further object of the invention to provide a device that can be retrofitted to existing lawnmowers or incorporated into newly manufactured lawnmowers.

Still another object of the invention is to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a direction changing feature for lawnmower discharge according to the present invention as attached to a lawnmower housing.

FIG. 2 is a perspective view of a direction changing feature for lawnmower discharge according to the present invention.

FIG. 3 is an exploded view of a direction changing feature for lawnmower discharge according to the present invention.

FIG. 4 is a perspective view of one of two hinge components for a direction changing feature for lawnmower discharge according to the present invention, the second hinge component being a mirror image.

Similar reference characters denote corresponding features consistently throughout the attached drawings.

### DETAILED DESCRIPTION OF THE PREFERRED EMBODIMENT

The present invention is a device that allows the operator of a lawnmower to select the side of the lawnmower from which the discharge exits.

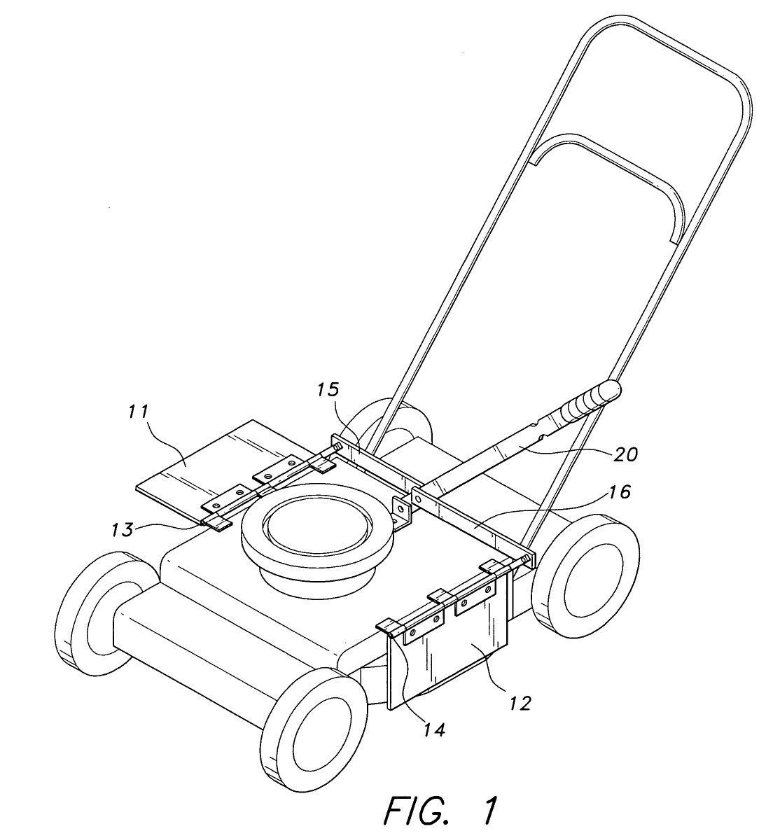

Referring to the drawings, FIGS. 1 through 4 illustrate the preferred embodiment of the present invention.

FIG. 1 shows the device comprised of two flaps 11 and 12 that are connected by linking rods 15 and 16 to a shift rod-20. Each flap 11, 12 is shaped and dimensioned to cover one of two openings on opposite sides of the lawnmower housing, and is attached to the lawnmower housing via hinges 13, 14, respectively.

The shift rod 20, which shifts by hand force between two positions (a left position and a right position), is shown in its right position. When the shift rod 20 is in this position, the right flap 12 covers an opening on the right side of the lawnmower housing and the left flap 11 extends horizontally from the lawnmower housing. Shifting the shift rod 20 to the left, causes the right flap 12 to pivot from a vertical position into a horizontal position thereby uncovering the opening on the right side and, simultaneously, causes the left flap 11 to pivot from a horizontal position into a vertical position thereby closing over the opening in the left side of the housing.

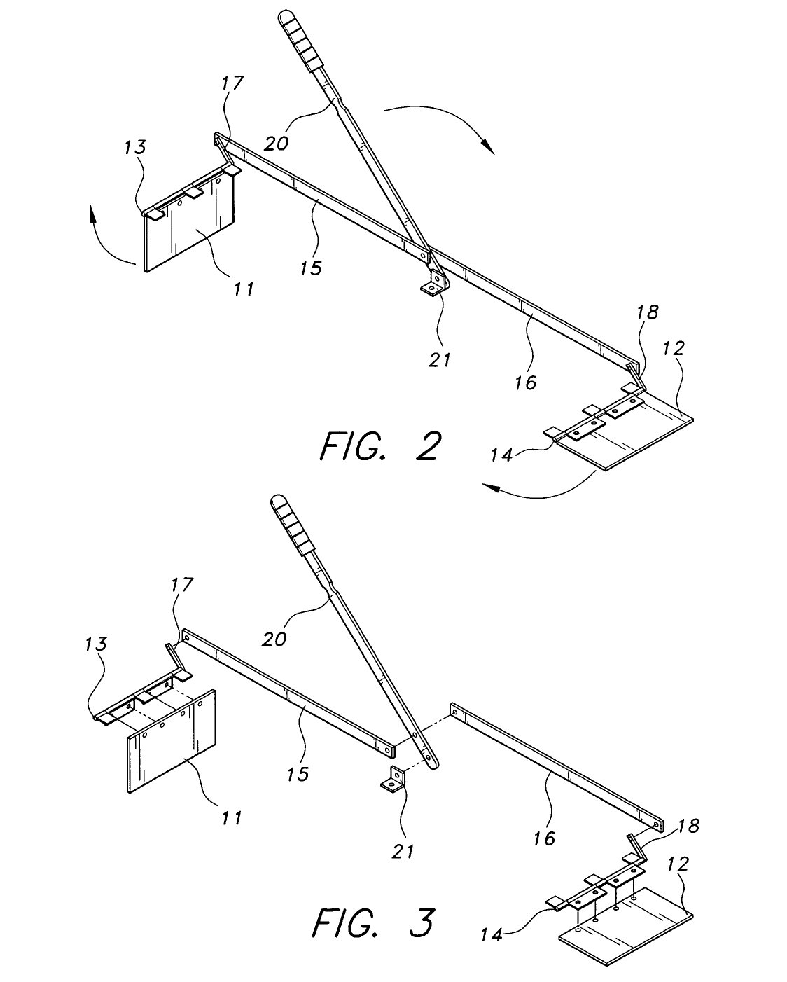

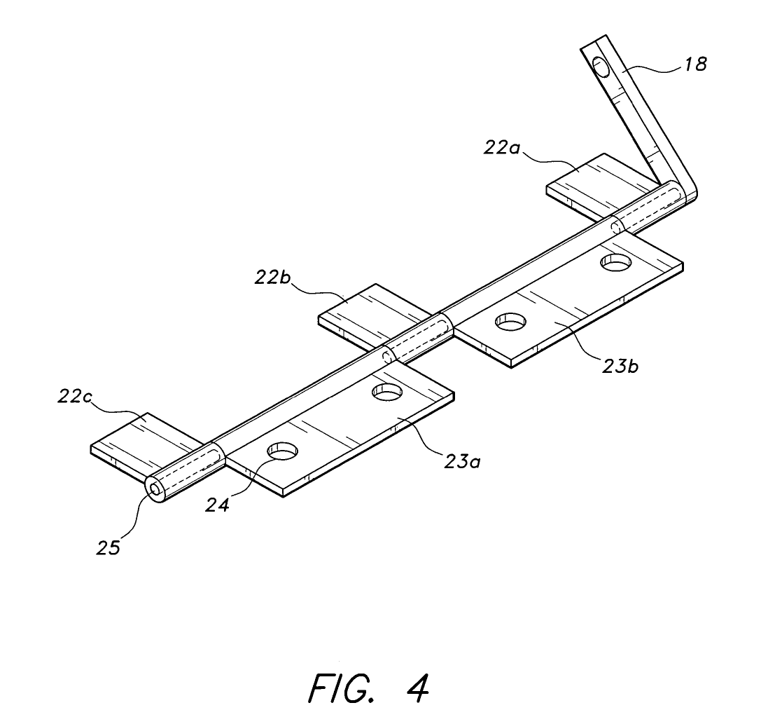

FIGS. 2 and 3 show an elevated view of the present invention, with FIG. 2 showing the device properly assembled and FIG. 3 showing an exploded view of the device. Each of the two flaps 11, 12 is attached to a hinge 13, 14, respectively. Each hinge 13, 14 has three tabs 22a, 22b and 22c (numbered in FIG. 4) used to secure it to a lawnmower housing, and has a linking arm 17 and 18 used to attach the hinge 13 or 14 to one end of a linking rod 15 or 16. One end of each linking rod 15, 16 is attached to the shift rod 20, and the other end of each linking rod 15, 16 is attached to a hinge linking arm 17, 18, respectively (see FIG. 3). One end of the shift rod 20 is attached to a shift rod bracket 21, which attaches to a lawnmower housing, and the other end of the shift rod 20 has a handle grip. When shifted to the right or the left, the shift rod 20 pivots at the point of its attachment to the shift rod bracket 21. Shifting of the shift rod 20 causes both linking rods 15 and 16 to move laterally in the direction that the shift rod 20 is moved. In turn, lateral movement of the linking rods 15 and 16 causes the hinge linking arms 17 and 18 to also move in the direction that the shift rod 20 is moved, thereby causing each hinge to rotate a flap 11, 12. When the shift rod 20 is moved to the left, the flaps 11 and 12 rotate in a counterclockwise direction, and when the shift rod 20 is moved to the right, the flaps 11 and 12 rotate in a clockwise direction, all in the sense of FIGS. 1, 2 and 3.

FIG. 4 shows one of the two hinges 13, 14. Three tabs 22a, 22b and 22c spin freely on the hinge pin(s) 25 and are used to secure the hinge 13 or 14 to the lawnmower housing. The hinge linking arm 17 or 18 and two flanges 23a and 22b are attached to the hinge pin(s) 25 and remain in a fixed position relative to the hinge pin 25. Each of the flanges 23a and 23b has two holes 24 for purposes of attaching a flap 11 and 12 to the hinge 13 or 14.

It is to be understood that the present invention is not limited to the sole embodiment described above, but encompasses any and all embodiments within the scope of the following claims.

I claim:

1. A lawnmower with a device for changing the direction of grass clipping discharge from the lawnmower housing, comprising:
a lawnmower having a housing with a first discharge opening and a second discharge opening; said first and second discharge openings disposed on opposite sides of said lawnmower housing;
a first flap adapted for covering said first discharge opening;
a second flap adapted for covering said second discharge opening; and
means for opening and closing said flaps;
wherein when said first flap is open to uncover the first discharge opening, said second flap is closed to cover the second discharge opening, and when said second flap is open to uncover the second discharge opening, said first flap is closed to cover the first discharge opening.

2. The lawnmower with the device for changing the direction of grass clipping discharge from the lawnmower as claimed in claim 1, further comprising hinges for mounting said first and second flaps on said lawnmower.

3. The lawnmower with the device for changing the direction of grass clipping discharge from the lawnmower as claimed in claim 2, further comprising a bracket fixed to said lawnmower, a shift rod pivotally mounted on said bracket, and linkages connecting said shift rod to said first and second flaps, such that movement of said rod in one direction lifts said first flap to expose said first discharge opening while lowering said second flap to close said second discharge opening, and movement of said shift rod in a direction opposite said one direction lifts said second flap to open said second discharge opening while lowering said first flap to close said first discharge opening.

4. A direction changing device for changing the direction of grass clipping discharge from a lawnmower having first and second discharge openings on opposite sides of the lawnmower housing, the direction changing feature comprising:
a first flap adapted for covering the first discharge opening;
a second flap adapted for covering the second discharge opening; and
means for opening and closing said flaps;
wherein when said first flap is open to uncover the first discharge opening, said second flap is closed to cover the second discharge opening, and when said second flap is open to uncover the second discharge opening, said first flap is closed to cover the first discharge opening.

5. The device for changing the direction of grass clipping discharge from a lawnmower as claimed in claim 1, further comprising hinges for mounting said first and second flaps on a lawnmower.

6. The device for changing the direction of grass clipping discharge from a lawnmower as claimed in claim 5, further comprising a bracket fixed to a lawnmower, a shift rod pivotally mounted on said bracket, and linkages connecting said shift rod to said first and second flaps, such that movement of said rod in one direction lifts said first flap to expose the first discharge opening while lowering said second flap to close the second discharge opening, and movement of said shift rod in a direction opposite said one direction lifts said second flap to open the second discharge opening while lowering said first flap to close the first discharge opening.
